(19) United States
(12) Patent Application Publication
(10) Pub. No.: US 2004/0201343 A1
(43) Pub. Date: Oct. 14, 2004

(54) Colour picture tube with improved shielding

(75) Inventors: Konrad Leutz, Ebersbach (DE); Rolf Reidinger, Ebersbach (DE)

Correspondence Address: Timothy E. Newholm, BOYLE, FREDRICKSON, NEWHOLM, STEIN & GRATZ, S.C., 250 Plaza, Suite 1030, 250 East Wisconsin Avenue, Milwaukee, WI, 53202, US

(73) Assignee: MT Picture Display Germany GmbH

(21) Appl. No.: 10/796,914

(22) Filed: Mar. 9, 2004

(30) Foreign Application Priority Data
Apr. 14, 2003 (EP) 03008062.6

(51) Int. Cl. H01J 29/06; H01J 29/80

(52) U.S. Cl. 313/402; 313/479

(57) ABSTRACT

The present invention relates to a colour picture tube and to a manufacturing method for a colour picture tube. The colour picture tube includes a shadow mask which is secured to a mask frame. In order to improve the shielding effect, a shielding plate, which shields external magnetic fields, is secured to at least one longitudinal bar of the mask frame. By means of such a shielding plate, the picture quality of a colour picture tube can be improved and the manufacturing efforts can be simplified in comparison with conventional colour picture tubes.

### BACKGROUND OF THE INVENTION

1. Field of the Invention

The invention relates to a colour picture tube with improved shielding against external magnetic fields and to a manufacturing method for such colour picture tubes. The invention relates in particular to a colour television set and a colour monitor, which are provided with such a colour picture tube.

2. Description of the Related Art

FIG. 1 shows a cross-section through a conventional colour picture tube. A colour picture tube consists essentially of a glass body 1 for which a front portion, the “screen tray”, and a conically shaped rear portion are combined in the manufacturing process. The inner side of the front screen 2 of the colour picture tube has applied thereto a luminescent layer with phosphor dots or phosphor strips. The electron beams for activating the phosphor dots are generated by an electron gun 3 which is arranged in the neck of the colour picture tube. The electric signals for controlling the electron gun 3 are supplied to said electron gun via contact pins from outside. By means of a deflection unit 4, which is mounted on the outer surface of the electron gun, the electron beams generated by said electron gun 3 are deflected such that all the pixels of the luminescent screen are activated one after the other.

At a distance of approx. 15 mm in front of the luminescent screen, a shadow mask is provided in the interior of the colour picture tube, said shadow mask being held in a mask frame 5. The shadow mask has a plurality of holes, each hole being associated with a phosphor triple on the luminescent screen. The holes are etched into the shadow mask at regular intervals and have a diameter of approx. 0.25 mm. The shadow mask is held by the mask frame 5 so as to impart sufficient mechanical stability to the mask and so as to guarantee its handability.

In order to protect the electron beams on their way from the electron gun 3 to the luminescent screen against the influence of the geomagnetic field, the colour picture tube is provided with a shielding cap 6 in the interior thereof. By means of such a shielding cap, colour impurities of the picture reproduced can be avoided, such colour impurities being caused by electron beams which fail to hit the respective phosphor dot or phosphor strip precisely. The shielding cap 6 arranged in the glass body 1 is produced from a highly permeable material.

In many colour picture tubes, also the mask frame 5 produces a shielding effect against the geomagnetic field. However, modem colour picture tubes often have mask frames which, due to additional requirements to be fulfilled, are produced from materials having a comparatively poor shielding effect. In the case of SST technology (Semi-Stretch-Tension technology) tension masks the frame is e.g. often produced from iron. Due to the high mechanical stress to which this tension frame is subjected, said frame has a magnetic permeability which is lower than that of the material of the shielding cap. The poorer shielding effect of the mask frame 5 affects in particular the axial field (Z field) in the direction of the tube axis.

In order to compensate the poorer shielding effect in the case of colour picture tubes having a mask frame made of less permeable material, the shielding cap can be extended in the direction of the screen so that the shielding cap also protects the mask frame. The shielding cap is extended such that in particular the longitudinal bars of the mask frame are protected.

In order to conduct the magnetic flux to the mask as effectively as possible, the extended shielding cap is welded to the mask frame. Interruptions of the magnetic flux can be avoided in this way. Interruptions of the magnetic flux to the mask cause components of the magnetic flux in the vertical (Y-) direction so that the electron beams are deflected in the horizontal (X-) direction.

However, welding of the shielding cap to the mask frame entails particular problems. The shielding cap can only be welded to the mask frame when the so-called “screen forming process”, i.e. the application of the luminescent layer to the inner surface of the screen, has been finished, i.e. immediately prior to the “fritting together” of the components screen tray and cone of the glass body.

The screen forming process in the production of the colour picture tube necessitates that the mask/frame combination, i.e. the shadow mask held in the frame, has been inserted in the screen tray. Otherwise, an exact application of the luminescent layer will not be possible. When the shielding cap is fixed by welding after the application of the luminescent layer, the luminescent layer will be damaged by welding spatter. It follows that additional operating steps are necessary in order to prevent the luminescent layer from being damaged. For this purpose, the mask/frame combination is “buttoned out” and removed from the screen tray. After the welding process, the mask frame and the shielding cap secured thereto are re-attached to the screen tray by “buttoning in”. Expensive and complicated production steps are necessary for buttoning said components out of and into the screen tray.

### OBJECTS AND SUMMARY OF THE INVENTION

It is the object of the present invention to provide a colour picture tube which is less difficult to produce and a corresponding manufacturing method for colour picture tubes.

This object is achieved by the features of the independent claims.

According to the present invention, the mask frame has secured thereto an additional shielding plate which protects said mask frame against external magnetic fields. The shielding plate is mounted on the outer surface of a longitudinal bar of the mask frame. When such a shielding plate is used, it will no longer be necessary to extend the shielding cap in the direction of the screen and to weld it to the mask frame. The shielding plate can be secured to the mask frame at a much earlier stage of the manufacturing process than the shielding cap, in particular prior to the application of the luminescent layer. In addition, the shielding cap itself need no longer be welded to the mask frame, but can easily be connected to the mask frame in a final step. A special advantage of the present invention is that a complicated removal and re-insertion of the mask/frame combination after the screen forming process can be dispensed with. It is therefore possible to produce a colour picture tube with good imaging properties in a simple way.

The shielding plate is preferably welded to the mask frame. A particularly good magnetic flux to the mask can be achieved in this way.

In order to achieve a good shielding effect, the shielding plate is preferably made of a highly permeable material.

According to a preferred embodiment, the shielding plate is a multi-part component or provided with slots that extend transversely to the longitudinal direction of the shielding plate. Such a multi-part embodiment of the shielding plate and also a slotted embodiment of the shielding plate allow the magnetic flux in said shielding plate to be influenced. In this way, it is possible to avoid detrimental influences on the movement of the electron beams and thus on the reproduction quality of the colour picture tube. According to a simple embodiment, the shielding plate is a two-part component or provided with a single slot. A more complicated guidance of the magnetic flux can be effected by means of a plurality of slots or a larger number of shielding plate components.

According to a preferred embodiment, the slot or the slots is/are arranged in the shielding plate in such a way that their position corresponds to the position of the vertical slots in the shielding cap.

According to another advantageous embodiment, the shielding plate is implemented such that it also fulfils the function of an electron shield, in addition to the function of shielding external magnetic fields. For this purpose, the shielding plate is also arranged on the mask-frame side facing the electron gun. The portion of the shielding plate facing the electron gun reflects the electrons impinging on the mask frame, said electrons being reflected in a direction away from then luminescent screen, so as to prevent background luminance on the luminescent screen caused by stray electrons, whereas the shielding-plate portion, which extends at right angles to said first-mentioned portion and which is arranged on the outer side of the mask frame, protects the movement of the electron beams within the colour picture tube against external magnetic fields. Due to the fact that the shielding plate fulfills more than one function, the production of the colour picture tube can be simplified still further and the production costs can be reduced.

The shielding plate is preferably secured to the longitudinal bars, i.e. to the upper and the lower bar of the mask frame.

The shielding cap is clipped onto the mask frame in a simple manner, prior to fritting together the screen tray and the cone of the glass body of the colour picture tube.

Other advantageous embodiments represent the subject matters of the subclaims.

### BRIEF DESCRIPTION OF THE DRAWINGS

Preferred embodiments of the invention will be explained hereinbelow making reference to the drawings; the individual figures of the drawings show:

FIG. 1 the schematic structural design of a conventional colour picture tube;

FIG. 2 a perspective view of a mask/frame combination of a colour picture tube in a first embodiment of the present invention, with a shielding cap secured to the mask/frame combination;

FIG. 3 a view according to FIG. 2, but without a shielding cap;

FIG. 4 a view according to FIG. 3, with shielding plates secured to the longitudinal bars of the mask/frame combination;

FIG. 5 a perspective schematic sketch of a shielding plate according to the present invention;

FIG. 6 a perspective view of a two-part shielding plate;

FIG. 7 a perspective view of a four-part shielding plate;

FIG. 8 a perspective view of a shielding plate according to the present invention provided with a slot;

FIG. 9 a perspective view of a shielding plate according to the present invention with a plurality of slots;

FIG. 10 a perspective view of a mask/frame combination, with a shielding cap according to a second embodiment of the present invention;

FIG. 11 a perspective view according to FIG. 10, without a shielding cap;

FIG. 12 a perspective view according to FIG. 11, in which the fastening of a shielding plate on one of the longitudinal bars of the colour picture tube is indicated;

FIG. 13 a perspective detail view of an L-shaped shielding plate;

FIG. 14 a perspective detail view of the L-shaped shielding plate according to FIG. 13, with clip holes;

FIG. 15 a perspective detail view of an embodiment of a U-shaped shielding plate, with clip holes; and

FIG. 16 a side view of the U-shaped shielding plate according to FIG. 15.

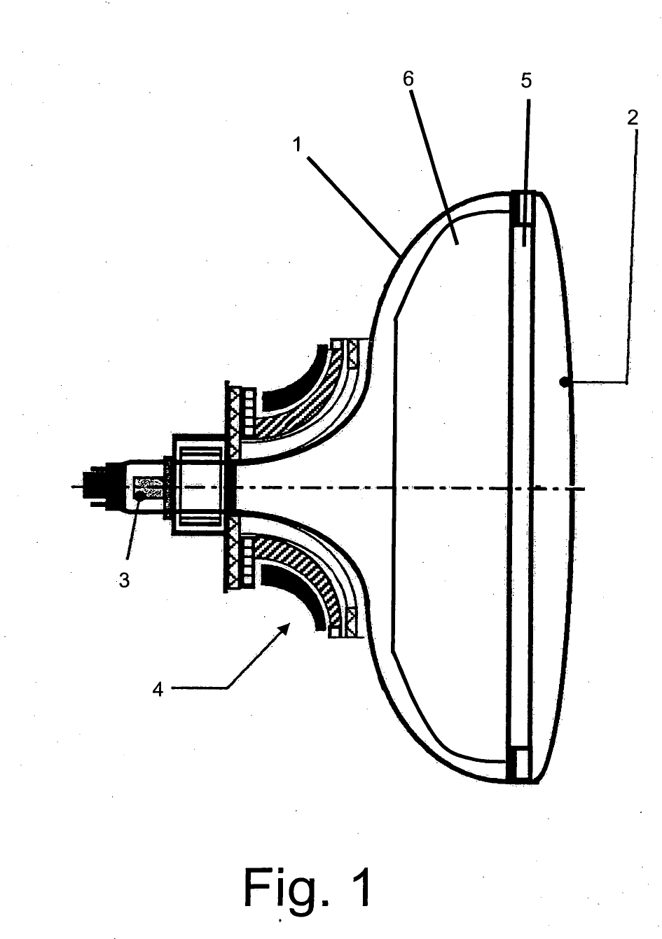

### DETAILED DESCRIPTION OF THE PREFERRED EMBODIMENTS

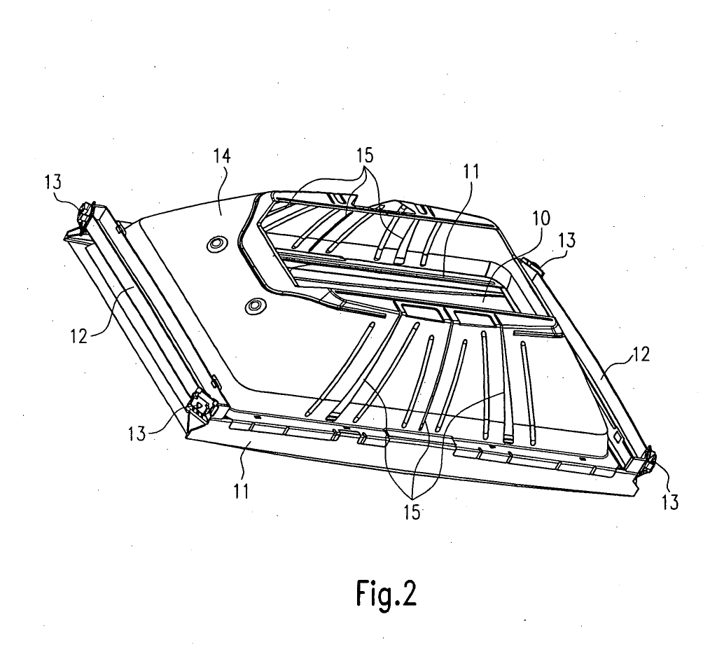

A first embodiment of the present invention is shown in FIG. 2 to 5. A mask frame is composed of longitudinal bars 11 and transverse bars 12. The mask frame has inserted therein the shadow mask so that the shadow mask and the mask frame 11, 12 define a “mask/frame combination”. The corners 13 of the mask/frame combination are provided with devices for fastening the mask/frame combination to the glass of the picture tube.

A shielding cap 14 is mounted on the mask frame 11, 12. The shielding cap 14 can be fastened to the mask frame via clips in a simple manner. For influencing the magnetic flux in the shielding cap 14, said shielding cap 14 is provided with vertical openings or vertical slots 15 at the longitudinal sides thereof. The vertical openings 15 allow a purposeful control of the magnetic flux in the shielding cap 14.

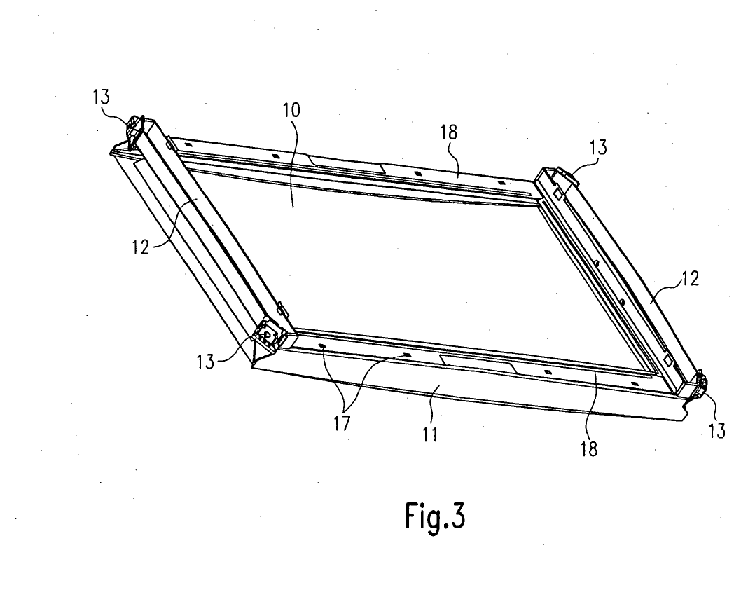

In FIG. 3, the clip holes 17 can be seen, which serve to fasten the shielding cap 14 to the mask frame 11, 12. The shielding cap 14 can therefore be secured to the mask frame in a simple manner, without any risk of damage being caused to the luminescent layer, as in the case of conventional fastening.

On the mask frame side facing the electron gun 3, an electron shield 18 is provided. The electron shield 18 reflects electrons impinging on the mask frame so that these electrons will not generate an undesirable background luminance as stray electrons.

In the mask frame shown in FIG. 4, each of the longitudinal bars 11 has secured thereto a respective shielding plate. The shielding plates 20 serve to shield external magnetic fields, in particular the geomagnetic field, and they are externally welded to the longitudinal bars 11 via welding spots 22. The shielding plate 20 is preferably fastened to the longitudinal bars 11 at an early stage of the manufacturing process, in any case prior to the screen forming process in which the luminescent layer is applied to the inner surface of the screen tray. Preferably, the shielding plate 20 is fastened to the longitudinal bar 11 before the mask/frame combination is inserted in the screen tray and preferably also before the mask 10 is inserted in the mask frame.

According to a preferred embodiment, the shielding plate 20 has a rectangular (L-shaped) profile with a forming edge 21. The shielding plate 20 is secured to the mask frame such that the respective outer side and the respective side facing the electron gun are fully or at least partly covered thereby.

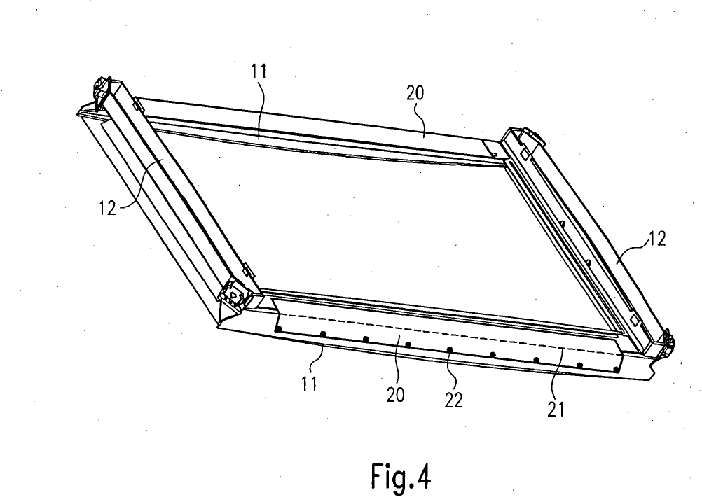

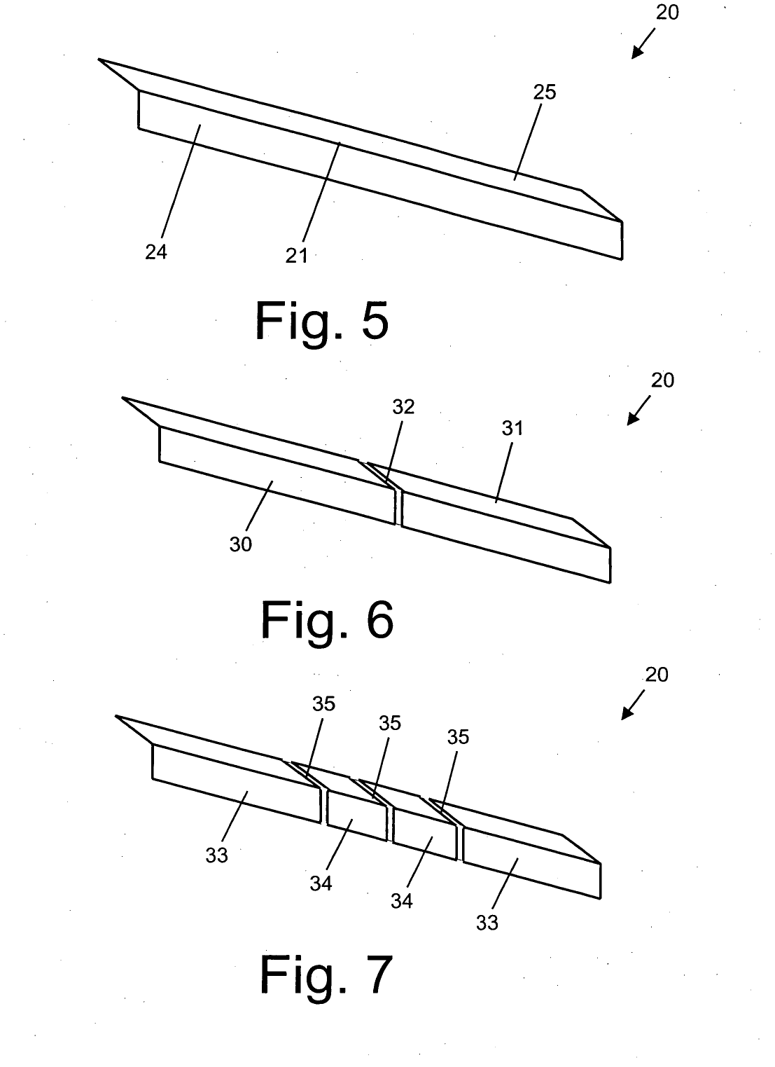

Examples for a possible structural design of the shielding plate are shown in FIG. 5 to 9. In FIG. 5, the shielding plate according to FIG. 4 is shown in detail. The shielding plate 20 comprises two portions 24, 25 which are arranged at right angles to one another with a forming edge 21 between them. For achieving a good shielding effect, the shielding plate is produced from a highly permeable material, preferably the same material that has been used for producing the shielding cap 14.

It is the task of the shielding plate 20 to compensate the magnetic properties of the mask frame, which are not as good as those of the shielding cap. In particular, the shielding plate 20 improves the poorer magnetic properties which are caused by the material of the mask frame and which allow only a weak magnetic flux from the shielding cap into the mask frame. Through the shielding plate according to the present invention, the magnetic flux of the axial field is interrupted much less than in the case of conventional arrangements so that only weaker vertical components of the magnetic field and therefore smaller charge displacements will be caused.

In order to reduce the horizontal component (i.e. in the X-direction) of the magnetic field, the shielding plate 20 is additionally provided with vertical slots or openings. Exemplary embodiments are shown in FIG. 6 to 9.

FIG. 6 shows a two-part shielding plate comprising the portions 30 and 31, which are mounted on the frame bar with a gap 32 of predefined width.

Another embodiment is shown in FIG. 7 where the shielding plate 20 comprises a total of four portions 33, 34, which are mounted on the frame bar such that a respective gap 35 of predefined width is defined between them.

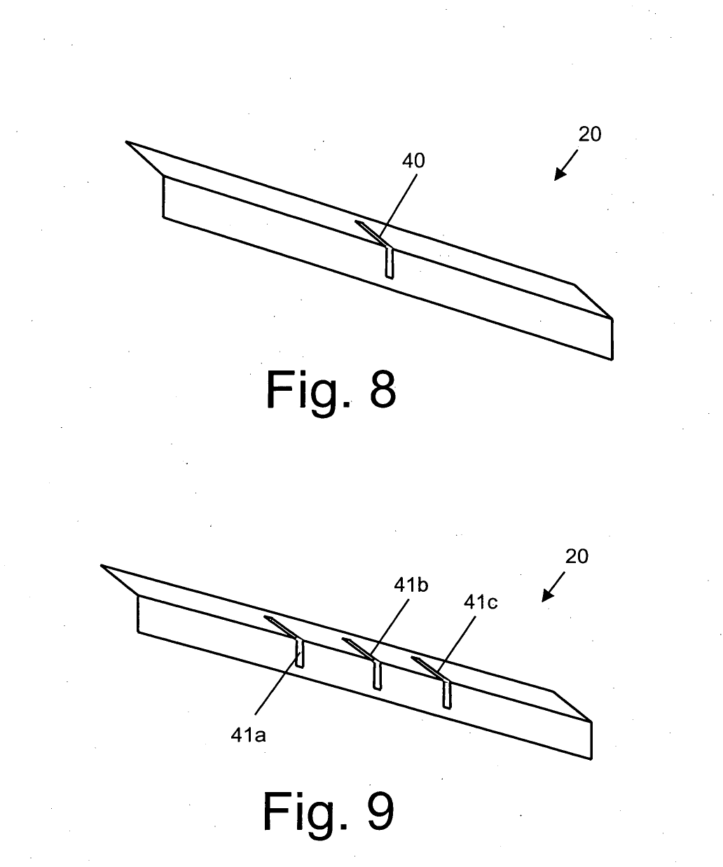

Structural designs of the shielding plate 20, which are analogous to those disclosed in FIGS. 6 and 7, are shown in FIGS. 8 and 9. Instead of a gap of predefined width between the parts of the shielding plate, the shielding plate is, however, provided with suitably arranged slots 40, 41.

The position of the slots 40, 41 and gaps 32, 35, respectively, corresponds preferably to those of the vertical slots 15 in the shielding cap 14, which can be seen e.g. in FIG. 2.

According to another preferred embodiment, the shielding plate 20 is simultaneously implemented as an electron screen/electron shield. In this embodiment the portion of the shielding plate facing the electron gun serves as an electron shield and the portion which covers, fully or partly, the outer side of the longitudinal bar serves as a shielding means.

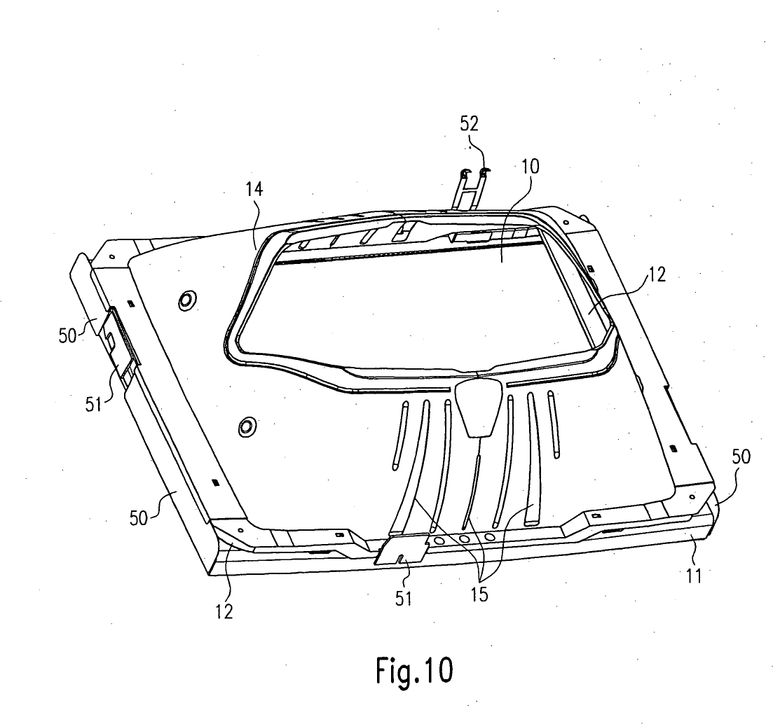

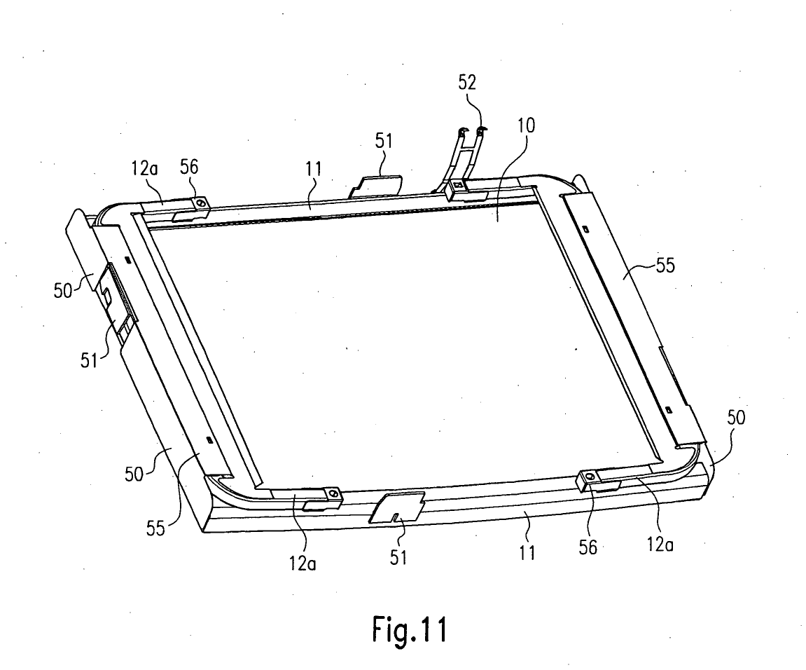

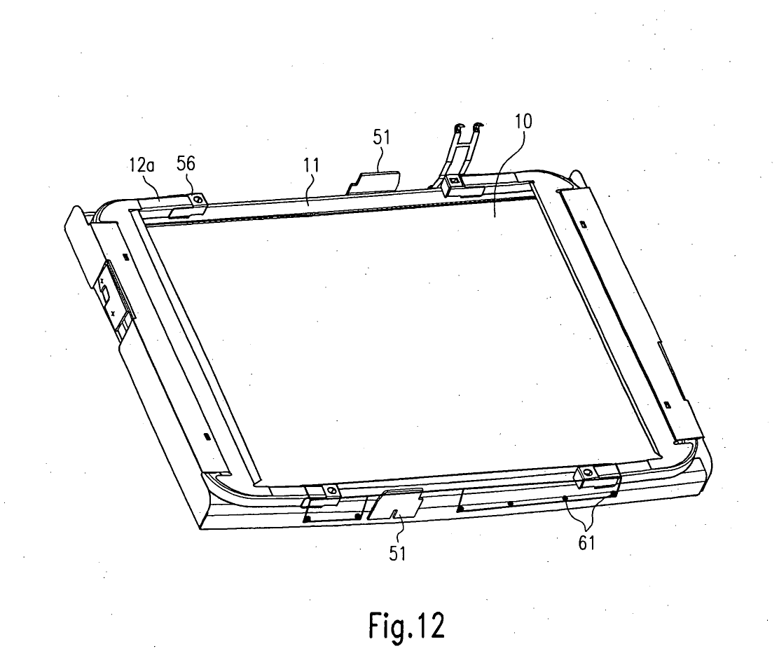

A further embodiment of the present invention for another configuration of the mask frame is shown in FIG. 10 to 12. The mask/frame combination of this embodiment does essentially not comprise any flat surfaces on the longitudinal bars. In comparison with the mask/frame combination shown in FIG. 2 to 5, it will therefore be more complicated to fasten a shielding cap.

In FIG. 10 to 12, corresponding reference numerals have been used for the same components, even if the two structural designs differ from one another with respect to details.

The embodiment of the mask frame shown in FIG. 10 to 12 comprises longitudinal bars 11 and transverse bars 12 welded onto said longitudinal bars. The transverse bars 12 are welded onto the longitudinal bars 11 via bent ends 12a. Both the transverse bars and the longitudinal bars are preferably made of iron. For fastening the mask/frame combination to the glass body of the colour picture tube, a spring holder 51 is provided on each side in the case of this embodiment. In addition, a contact spring 52 is shown, which establishes a conductive connection to an inner coating of the glass body.

For fastening the shielding cap 14, clip holders 56 with clip holes are provided on the bent ends of the lateral bars 12a.

In contrast to the embodiment of FIG. 2 to 5, the shielding plate is not secured directly to the surface of the longitudinal bar 11, but to the bent ends 12a of the lateral bars. The L-shaped shielding plate 60 is mounted on the bent ends 12a of the lateral bars and bridges in this way the differences in height of the frame structure.

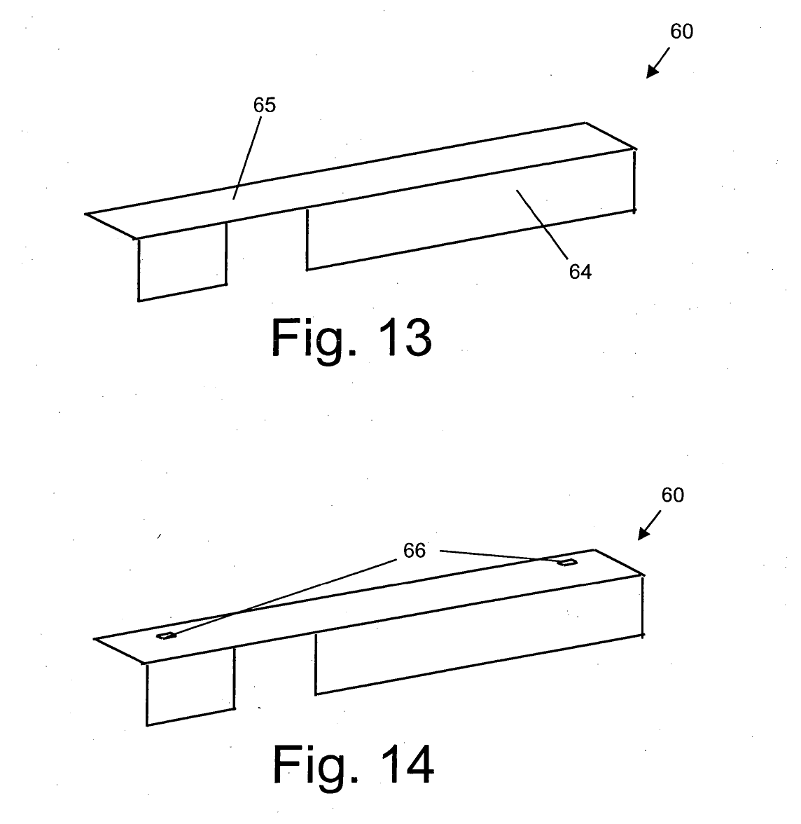

Variations of exemplary embodiments of the shielding plate 60 are shown in FIG. 13 to 16. FIG. 13 shows a perspective view of the shielding plate 60 comprising a portion 64 which shields the mask frame on the outer side thereof and a portion 65 which extends at right angles to said portion 64 and which is arranged on the longitudinal-bar side facing the electron gun.

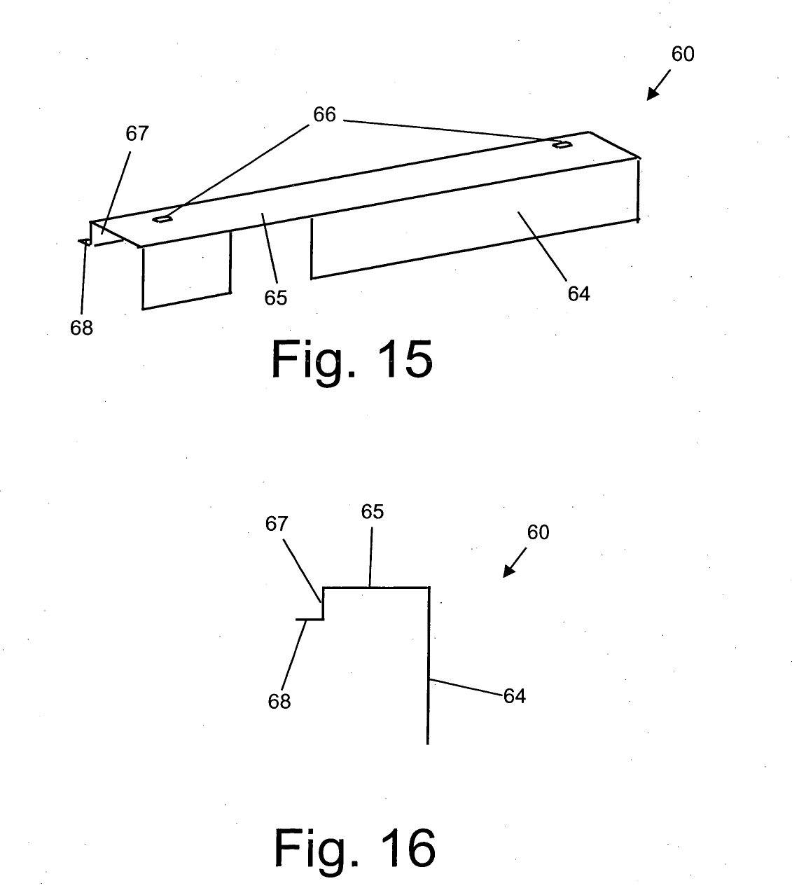

According to an advantageous embodiment of the colour picture tube shown in FIGS. 14 and 15, the clip holders 56 on the mask frame are replaced by clip holes 66 which are provided in the shielding plate 60 so that the complicated welding of clip holders 56 to the mask frame can be dispensed with. The clip holes 66 are provided in the portion 65 of the shielding plate.

Due to the fact that the shielding plate 60 bridges the differences in height on the longitudinal side of the frame, the shielding cap can be given an essentially flat structural design in these areas, and this will again simplify the manufacturing process of said shielding cap.

The shielding plate 60 is preferably L-shaped in cross-section (cf. FIGS. 13 and 14) or U-shaped in cross-section (cf. FIGS. 15 and 16). For this purpose, the shielding plate is bent either only once by approx. 90° during the manufacturing process or, for the U shape, twice by approx. 90° in the course of the manufacturing process. Whereas the shielding plate 60 having an L-shaped cross-section is secured only to the outer side of the mask frame via welding spots 61, the U-shaped shielding plate 60 is welded also to the inner side of the frame. The shielding plate includes, for this purpose, at least one additional portion 67 which abuts on and is secured to at least the inner side of the bent ends 12a of the transverse bars 12, preferably also to the inner side of the longitudinal bar 11. The mechanical stability of the shielding plate can be increased markedly in this way and a mechanically firm fastening of the shielding cap to the shielding plate can be achieved easily.

A further increase in the mechanical stability of the shielding plate 60 can be achieved by an additional portion 68. For this purpose, the shielding plate is bent once more by approx. 90° in the opposite direction during the manufacturing process. Whereas the ends of the portion 67 abut on and are secured (i.e. normally welded) to the ends 12a of the transverse bars 12, the additional portion 68 rests again on the longitudinal bar. An increase in strength is already achieved by the additional forming edge. A further increase can be achieved in that this portion is fixedly connected to the surface of the longitudinal bar 11, i.e. preferably again welded to said surface.

Although in the embodiments shown, the respective shielding plate 20, 60 extends essentially over the entire length of the longitudinal bar, the shielding plate may just as well extend over only part of the bar. The resultant component of the magnetic field can advantageously be influenced once more in this way.

Summarizing, the present invention relates to a colour picture tube and to a manufacturing method for a colour picture tube. The colour picture tube includes a shadow mask which is secured to a mask frame. In order to improve the shielding effect, a shielding plate, which shields external magnetic fields, is secured to at least one longitudinal bar of the mask frame. By means of such a shielding plate, the picture quality of a colour picture tube can be improved and the manufacturing efforts can be simplified in comparison with conventional colour picture tubes.

We claim:

1. A colour picture tube comprising an essentially rectangular shadow mask, a mask frame composed of transverse bars and longitudinal bars and supporting said shadow mask, a shielding cap mounted on said mask frame, and a shielding plate secured to a longitudinal bar of the mask frame and covering at least part of the outer side of said longitudinal bar.

2. A colour picture tube according to claim 1, wherein the shielding plate is welded to the mask frame.

3. A colour picture tube according to claim 1, wherein the shielding plate is made of a highly permeable material.

4. A colour picture tube according to claim 1, wherein the shielding plate is a multi-part component.

5. A colour picture tube according to claim 4, wherein the shielding plate is a two-part component.

6. A colour picture tube according to claim 4, wherein the shielding plate is a four-part component.

7. A colour picture tube according to claim 1, wherein the shielding plate is provided with at least one slot for influencing the magnetic flux.

8. A colour picture tube according to claim 7, wherein at least one slot in the shielding plate is oriented at right angles to the longitudinal direction of the bar.

9. A colour picture tube according to claim 7, wherein the position of the at least one slot in the shielding plate is oriented according to the position of a slot provided in the shielding cap.

10. A colour picture tube according to claim 1, wherein the shielding plate is implemented such that it also fulfils the function of an electron shield.

11. A colour picture tube according to claim 10, wherein the shielding plate essentially covers the side of the longitudinal bar of the mask frame facing the electron gun of the colour picture tube, said mask frame having the shielding plate secured thereto.

12. A colour picture tube according to claim 1, wherein the shielding plate is L-shaped.

13. A colour picture tube according to claim 1, wherein the shielding plate is U-shaped.

14. A colour picture tube according to claim 13, wherein the shielding plate is welded to both sides of the longitudinal bar.

15. A colour picture tube according to claim 13, wherein the shielding plate is additionally welded to the ends of the transverse bars.

16. A colour picture tube according to claim 13, wherein the shielding plate includes a further portion facing the interior of the colour picture tube, said portion being located on the inner side of the mask frame.

17. A colour picture tube according to claim 15, wherein the further portion of the shielding plate is welded to the longitudinal bar.

18. A colour picture tube according to claim 1, wherein the shielding plate has provided therein clip holes for securing the shielding cap in position.

19. A colour picture tube according to claim 1, wherein the shielding cap is adapted to be clipped onto the mask frame.

20. A colour monitor or television set with a colour picture tube according to claim 1.

21. A manufacturing method for a colour picture tube comprising a glass body, which is composed of a screen tray and a cone, said method comprising the steps of:
producing a mask frame from transverse bars and longitudinal bars,
inserting a mask into the mask frame, said mask and mask frame defining together a mask/frame combination,
inserting the mask/frame combination into the screen tray,
applying a luminescent layer to the inner side of the screen,
fastening a shielding cap to the mask frame, and
connecting the screen tray and the cone,
wherein a shielding plate is mounted on at least one longitudinal bar of the mask frame prior to inserting the mask/frame combination into the screen tray.

22. A manufacturing method according to claim 21, wherein the shielding plate is welded to the mask frame.

23. A manufacturing method according to claim 22, wherein the shielding plate is welded to the outer side of the longitudinal bar.

24. A manufacturing method according to claim 22, wherein the shielding plate is additionally welded to the inner side of the mask frame.

25. A manufacturing method according to claim 24, wherein the shielding plate is welded to the longitudinal-bar side facing the interior of the colour picture tube.

26. A manufacturing method according to claim 24, wherein the shielding plate is welded to the ends of the transverse bars.

27. A manufacturing method according to claim 26, wherein the shielding plate is welded, via an additional portion, to the longitudinal-bar side facing the electron gun of the colour picture tube.

28. A manufacturing method according to claim 21, wherein the shielding cap is clipped onto the mask frame during the fastening step.

29. A manufacturing method according to claim 28, wherein the shielding cap is clipped onto the mask frame via clip holes provided in the shielding plate.
